(19) United States
(12) Patent Application Publication
(10) Pub. No.: US 2015/0301598 A1
(43) Pub. Date: Oct. 22, 2015

(54) METHOD, ELECTRONIC DEVICE, AND COMPUTER PROGRAM PRODUCT

(71) Applicant: Kabushiki Kaisha Toshiba, Tokyo (JP)

(72) Inventor: Yoshiyasu ITOH, Mitaka Tokyo (JP)

(21) Appl. No.: 14/579,815

(22) Filed: Dec. 22, 2014

Related U.S. Application Data
(60) Provisional application No. 61/982,564, filed on Apr. 22, 2014.

(51) Int. Cl. G06F 3/01; G06F 3/041; G06F 3/038

(52) U.S. Cl. CPC G06F 3/013; G06F 3/038; G06F 3/0418

(57) ABSTRACT

According to one embodiment, a method includes acquiring first image data including first information at a first time by capturing an image of a user's eye; acquiring a first coordinate at a second time substantially the same as the first time; and calculating a calibration value using first information and the first coordinate. The first information is information related to a first position of a user's eye. The first coordinate is a coordinate of a pointer including to move in a display area on a first screen by following an operation of a pointing device by a user, or a coordinate of a touched position at which a user touches a display area of a touch panel. The calibration value is a value for estimating a second position at which a user is looking in the display area.

### CROSS-REFERENCE TO RELATED APPLICATIONS

This application claims the benefit of U.S. Provisional Patent Application No. 61/982,564, filed Apr. 22, 2014.

### FIELD

Embodiments described herein relate generally to a method, an electronic device, and a computer program product.

### BACKGROUND

Conventionally, there has been known an electronic device that comprises a display and operates based on a user's line of sight detected by a camera or the like.

In the above electronic device, there might be some error between a position at which the user is supposedly looking on the display and a position at which the user is actually looking. Here, the position at which the user is supposedly looking on the display is calculated based on a detection result of the camera or the like. It is desirable for the electronic device to be able to calculate a calibration value for calibrating such error more easily.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram illustrating an example of a personal computer (PC) according to a first embodiment;

FIG. 2 is an exemplary schematic diagram illustrating an example of an operation method for the PC in the first embodiment;

FIG. 3 is an exemplary schematic diagram illustrating an example of another operation method that is different from the example illustrated in FIG. 2 for the PC in the first embodiment;

FIG. 4 is an exemplary schematic diagram illustrating an example of another operation method that is different from the examples illustrated in FIGS. 2 and 3 for the PC in the first embodiment;

FIG. 5 is an exemplary block diagram illustrating an example of a hardware configuration of the PC in the first embodiment;

FIG. 6 is an exemplary schematic diagram illustrating an example of a functional configuration of a calibration program in the first embodiment;

FIG. 7 is an exemplary schematic diagram illustrating an example of a calibration screen in the first embodiment;

FIG. 8 is an exemplary schematic diagram illustrating an example in which a part of the calibration screen is displayed in an emphasized manner in the first embodiment;

FIG. 9 is an exemplary flowchart illustrating an example of processing performed by modules of the calibration program in the first embodiment; and

FIG. 10 is an exemplary flowchart of processing performed by modules of a calibration program according to a second embodiment.

### DETAILED DESCRIPTION

Generally, a method according to one embodiment comprises acquiring first image data comprising first information at a first time by capturing an image of a user's eye; acquiring a first coordinate at a second time substantially the same as the first time; and calculating a calibration value using the first information and the first coordinates. The first information is information related to a first position of a user's eye. The first coordinates is a coordinate of a pointer comprising to move in a display area on a first screen by following an operation of a pointing device by a user, or a coordinate of a touched position at which a user touches a display area of a touch panel. The calibration value is a value for estimating a second position at which a user is looking in the display area.

Some embodiments will now be explained specifically with reference to some drawings. In the example explained hereunder, the technology according to the embodiments is used in a laptop personal computer (PC), but the technology according to the embodiment may be used in any other electronic devices other than PCs.

### First Embodiment

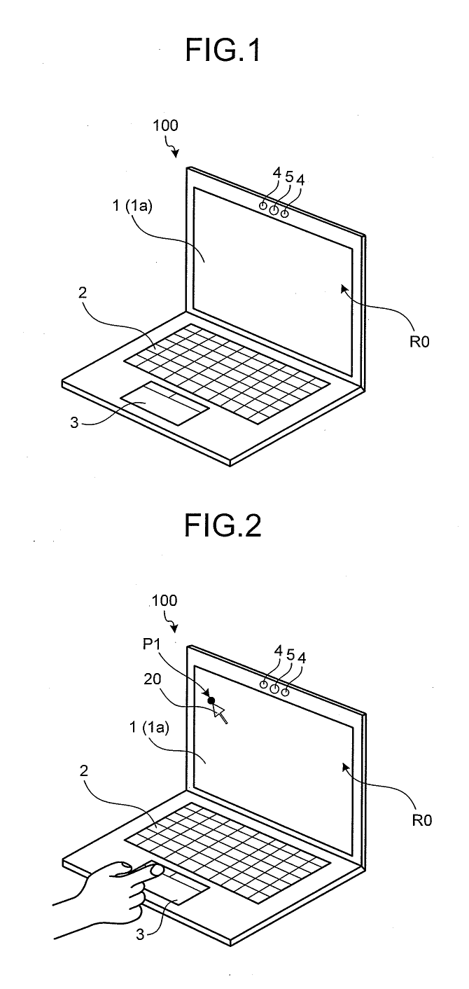

To begin with, a configuration of a PC 100 according to a first embodiment will be described with reference to FIGS. 1 to 8. The PC 100 is an example of an “electronic device”.

As illustrated in FIG. 1, the PC 100 comprises a display 1, a keyboard 2, a touch pad 3, an infrared light emitting diode (LED) 4, and an infrared camera 5.

The display 1 has a display area R0 in which still images, moving images and the like are displayed. A touch panel la is provided on the display 1. The touch panel 1a, the keyboard 2, and the touch pad 3 are input interfaces that are used for operating the PC 100.

For example, a user can perform various operations on the PC 100 by operating a cursor 20 displayed in the display area R0 using a pointing device such as the touch pad 3, as illustrated in FIG. 2. The cursor 20 is configured to move in the display area R0 by following an operation of the touch pad 3 by the user. The cursor 20 is an example of a “pointer”, and is an example of a “first image”.

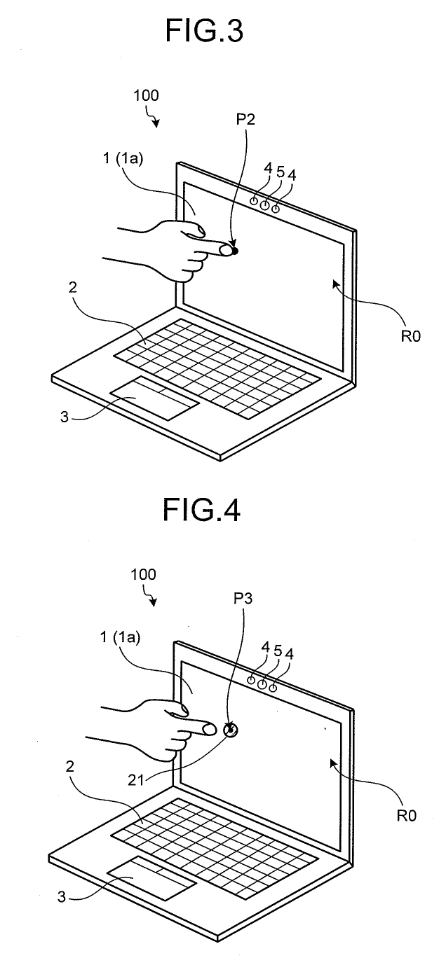

As another example, a user can also perform various operations on the PC 100 by touching the touch panel 1a on the display area R0 with a finger or a pointing device such as a stylus, as illustrated in FIG. 3.

As another example, a user can make various operations on the PC 100 by operating the hover image 21, as illustrated in FIG. 4. The hover image 21 is displayed on the display area R0 by a hover operation that is an operation of pointing to the touch panel 1a with the user's finger or a pointing device such as a stylus without touching the touch panel 1a. The hover image 21 moves in the display area R0 following a movement of the user's finger, the stylus, or the like. The hover image 21 is an example of a “pointer”, and is an example of the “first image”.

The pointing device according to the embodiment may be any device allowing a user to designate coordinates in the display area R0 of the display 1, by operating the pointing device. Examples of the pointing device not only include the touch pad 3 and the stylus, but also include a joystick, a pointing stick (track point), a data glove, a track ball, a pen tablet, a mouse, a light pen, a joy pad, and a digitizer pen. The pointer according to the embodiment may also be any indicator, including the cursor 20 and the hover image 21, allowing a user to recognize the coordinates designated with the pointing device.

The infrared LED 4 is configured to emit infrared light toward the user. The infrared camera 5 is configured to detect the user's line of sight using corneal reflection method. More specifically, the infrared camera 5 is configured to acquire image data including information (first information) related to the position of a user's eye by capturing an image of the user's eye. The first information is information indicating a positional relation between the position of a reflected light on the pupil of the user and the position of the reflected light on the cornea of the user. The reflected light is an infrared light emitted from the infrared LED 4 that is reflected on the cornea of the user. The infrared camera 5 is configured to detect a position at which the user is looking in the display area R0 based on the acquired first information. Explained in the first embodiment is an example in which the user's line of sight is detected using the corneal reflection method, but may be detected in any other ways than with the corneal reflection method.

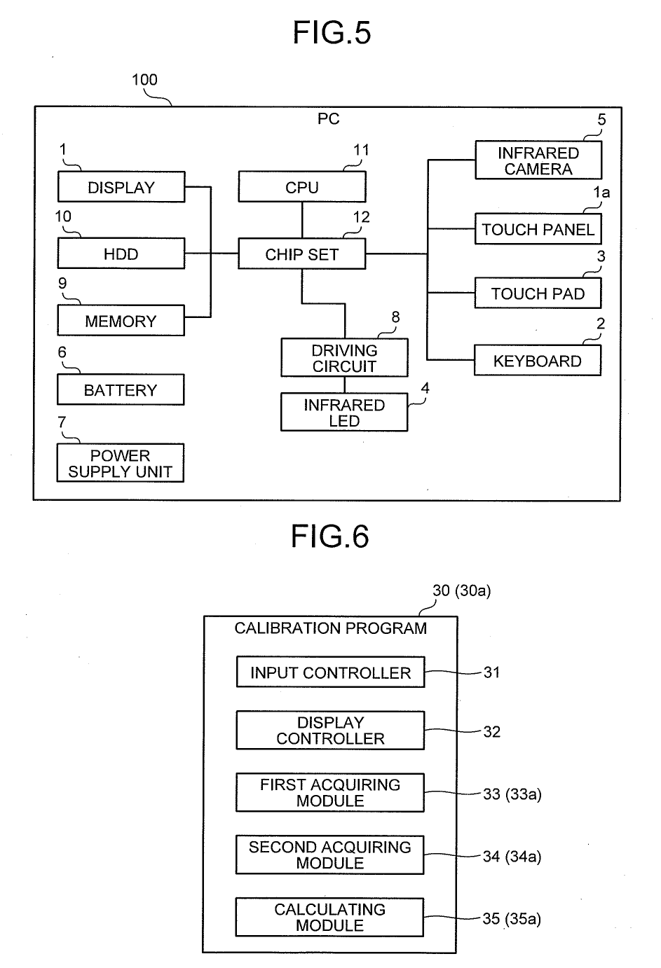

The PC 100 also comprises a battery 6, a power supply unit 7, a driving circuit 8, a memory 9, a hard disk drive (HDD) 10, a central processing unit (CPU) 11, and a chip set 12, as illustrated in FIG. 5, in addition to the devices described above.

The battery 6 is configured to store therein electrical energy. The power supply unit 7 is configured to supply the electrical energy stored in the battery 6 to the components of the PC 100. The driving circuit 8 is configured to drive the infrared LED 4.

The memory 9 is a main storage of the PC 100. The memory 9 comprises a read-only memory (ROM) and a random access memory (RAM). The HDD 10 is an auxiliary storage of the PC 100. In the first embodiment, a solid state drive (SSD), for example, may be provided instead of or in addition to the HDD 10.

The CPU 11 is configured to control the components of the PC 100 by executing various application programs stored in the memory 9 or the like. The chip set 12 is configured to manage data exchange between the components of the PC 100, for example.

The PC 100 according to the first embodiment is configured to be capable of operating based on a user's line of sight detected by the infrared camera 5. In other words, a user can operate, for example, an object displayed in an area of the display area R0, just by looking at the area. For example, in the example illustrated in FIG. 2, a user can achieve the same result as selecting the object at a point P1 using the cursor 20 just by looking at an area including the point P1. For example, in another example illustrated in FIG. 3, a user can achieve the same result as touching the object at a point P2 with a finger or a stylus just by looking at an area including the point P2. For example, another example illustrated in FIG. 4, a user can achieve the same result as performing an operation for displaying the hover image 21 at a point P3 just by looking at an area including the point P3.

In such a configuration, however, if there is an error between the position at which user's line of sight reaches the display area R0 that is determined based on a detection result of the infrared camera 5, and the position at which the user is actually looking in the display area R0, the PC 100 may perform an operation not intended by the user. It is therefore desirable to reduce such error in the detection of the line of sight.

Generally, when a user operates the cursor 20 in the display area R0 to operate the PC 100, the user often looks at the point pointed by the cursor 20 (see the point P1 in FIG. 2). In addition, when a user touches the touch panel 1a with a finger or a stylus to operate the PC 100, the user often looks at the touched point (see the point P2 in FIG. 3). Further, when a user displays the hover image 21 in the display area R0 to operate the PC 100, the user often looks at the point at which the hover image 21 is displayed (see the point P3 in FIG. 4).

Therefore, it becomes possible to determine the position at which the user is presumed to be actually looking at in the display area R0 by acquiring the coordinates (first coordinates) of any one of the position at which the cursor 20 is displayed (see the point P1 in FIG. 2), the touched position (see the point P2 in FIG. 3), and the position at which the hover image 21 is displayed (see the point P3 in FIG. 4). In addition, by comparing the acquired first coordinates with the first information (information suggesting the position at which the user is looking in the display area R0) included in the image data that is acquired by the infrared camera 5 when the first coordinates are acquired, it becomes possible to determine an error between the first coordinates and the position at which the user is actually looking in the display area R0 at some accuracy, and to calculate a calibration value for reducing the error. The calibration value is a setting value that is set when the position at which the user is looking in the display area R0 is estimated.

The CPU 11 according to the first embodiment executes a calibration program 30 illustrated in FIG. 6, as a computer program for calculating the calibration value. This calibration program 30 is executed only once, when the PC 100 is operated for the first time with a line-of-sight detection. As illustrated in FIG. 6, the calibration program 30 comprises, as a functional configuration, an input controller 31, a display controller 32, a first acquiring module 33, a second acquiring module 34, and a calculating module 35.

The display controller 32 is configured to receive input operations performed by a user using the touch panel 1a, the keyboard 2, or the touch pad 3. The display controller 32 is configured to control what is to be displayed on the display area R0.

The first acquiring module 33 is configured to acquire the image data including the first information related to the position of the user's eye at the first time by capturing an image of the user's eye with the infrared camera 5. The first information is information indicating the positional relation between the position of a reflected light on the user's pupil and the position of the reflected light on the user's cornea, the reflected light being an infrared emitted from the infrared LED 4 that is reflected on the cornea of the user, as mentioned earlier. The first acquiring module 33 is configured to acquire the image data including the first information when a user makes an operation of selecting an object displayed in the display area R0, for example.

The second acquiring module 34 is configured to acquire the first coordinates at the second time that is substantially the same as the first time. The first coordinates are, as mentioned earlier, one of the coordinates of the position at which the cursor 20 is displayed (see point P1 in FIG. 2), the position of the touch panel 1a touched by the user (see point P2 in FIG. 3), and the position at which the hover image 21 is displayed (see point P3 in FIG. 4), in the display area R0. The second acquiring module 34 is also configured to acquire the first coordinates when the user performs an operation of selecting an object displayed in the display area R0, for example, in the same manner as the first acquiring module 33.

The calculating module 35 is configured to perform various determinations and operations when the calibration program 30 is executed. For example, the calculating module 35 is configured to calculate a calibration value for estimating the position at which a user is presumably looking in the display area R0, based on the first coordinates acquired by the second acquiring module 34 and the first information included in the image data acquired by the first acquiring module 33 when the first coordinates are acquired. The calibration value thus calculated is stored in a storage medium such as the memory 9 or the HDD 10 (see FIG. 5). The calibration value stored in the storage medium is read as required, when a line of sight is detected using the infrared camera 5.

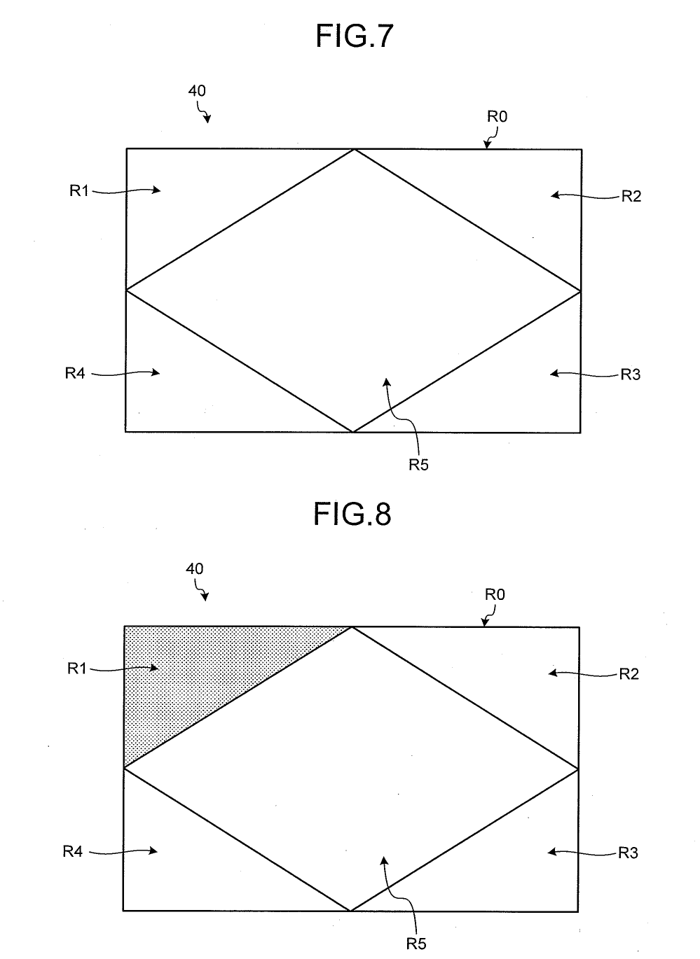

In the first embodiment, when the calibration program 30 is executed, to begin with, the display controller 32 is configured to display a calibration screen 40 illustrated in FIG. 7 in the display area R0. The calibration screen 40 is divided into a plurality of sections (five sections in FIG. 7). These sections of the calibration screen 40 correspond to a plurality of (five) areas R1 to R5 to be looked at, which are the sections of the display area R0.

In the example illustrated in FIG. 7, the display area RO has a rectangular shape, and the areas R1 to R4 are provided at positions corresponding to four corners of the display area RO. The area R5 is provided at a position corresponding to an area between the areas R1 to R4 that are positioned at the four corners in the display area R0. That is, the area R5 is provided at a position corresponding to the center area of the display area R0.

The display controller 32 is configured to display a section of the calibration screen 40 in an emphasized manner, one section at a time. In the example illustrated in FIG. 8, the area R1, corresponding to the upper left corner of the display area R0, in the calibration screen 40 is displayed in an emphasized manner. On the calibration screen 40, the display controller 32 is configured to display a message indicating the user to make a predetermined operation to the area displayed in an emphasized manner. Examples of the predetermined operation include an operation for selecting and determining the area displayed in an emphasized manner with the cursor 20 by operating the touch pad 3 (see FIG. 2), an operation of touching the area displayed in an emphasized manner with a finger or a stylus (see FIG. 3), and an operation for displaying the hover image 21 by bringing a finger or a stylus near the area displayed in an emphasized manner (see FIG. 4).

When the predetermined operation is performed by the user, the first acquiring module 33 is configured to acquire the image data (first information), and the second acquiring module 34 is configured to acquire the first coordinates. The calculating module 35 is configured to determine whether the first coordinates acquired by the second acquiring module 34 are positioned inside the area displayed in an emphasized manner in the calibration screen 40. If the calculating module 35 determines that the first coordinates are positioned inside the area displayed in an emphasized manner, the calculating module 35 is configured to store correspondence between the first information and the first coordinates at that timing.

The calculating module 35 is configured to determine whether the first coordinates are positioned inside the area every time the area displayed in an emphasized manner is switched in the calibration screen 40. If the calculating module 35 determines that the first coordinates are positioned inside the area displayed in an emphasized manner, the calculating module 35 is configured to store the correspondence between the first information and the first coordinates at that timing. The calculating module 35 then calculates a calibration value based on all the stored correspondence between the first information and the first coordinates.

Generally, although the user is often looking at the position at which the cursor 20 is displayed, the touched position, or the position at which the hover image 21 is displayed while the user is performing the predetermined operation, the user may remove his/her line of sight from such a position after performing the above predetermined operation. In the first embodiment, therefore, the second acquiring module 34 is configured to acquire the first coordinates after the first acquiring module 33 acquires the image data (first information).

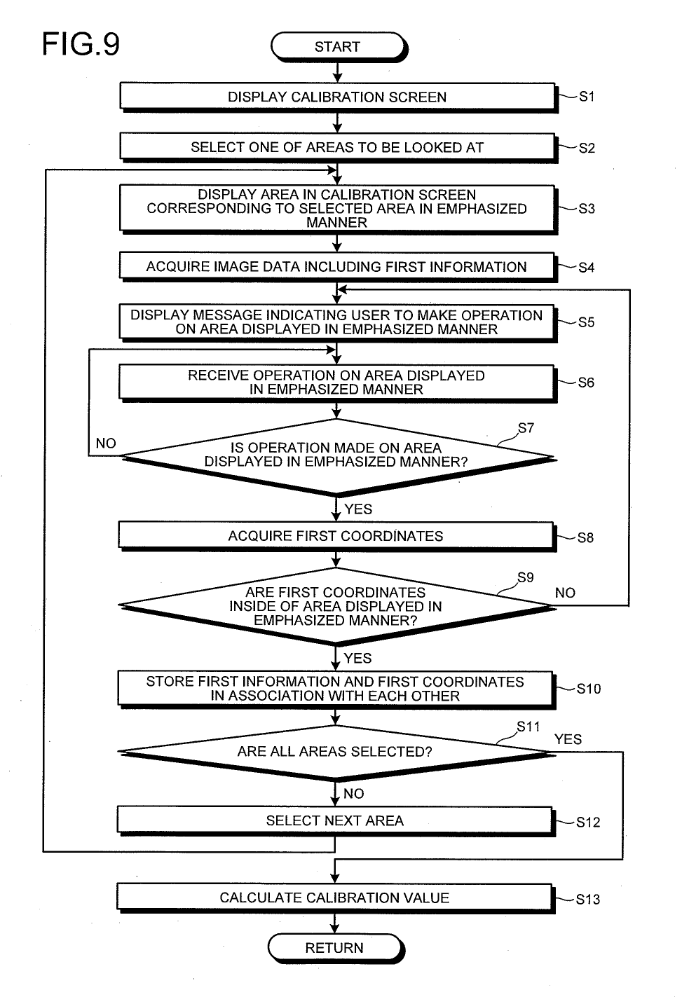

An exemplary processing performed by the modules of the calibration program 30 according to the first embodiment will now be described with reference to FIG. 9.

When the calibration program 30 is started, as illustrated in FIG. 9, at S1, the display controller 32 displays the calibration screen 40 in the display area R0 (see FIG. 7). The calibration screen 40 is divided into a plurality of sections, and these sections of the calibration screen 40 correspond to a plurality of areas R1 to R5, which are the sections of the display area R0. The processing then goes to S2.

At S2, the calculating module 35 selects one of the areas R1 to R5 to be looked at. The processing then goes to S3.

At S3, the display controller 32 displays an area in the calibration screen 40 in an emphasized manner (see FIG. 8), the area corresponding to one of the areas R1 to R5 selected at S2 (or at S12 described later). In FIG. 8, the area corresponding to the area R1 provided at the upper left corner of the calibration screen 40 is displayed in an emphasized manner, as an example. The processing then goes to S4.

At S4, the first acquiring module 33 acquires the image data including the first information by capturing an image of a user's eye with the infrared camera 5. The first information is information indicating a positional relation between the position of a reflected light on the user' s pupil and the position of the reflected light on the user's cornea, the reflected light being an infrared emitted from the infrared LED 4 that is reflected on the user's cornea, as mentioned earlier. The processing then goes to S5.

At S5, on the calibration screen 40 (see FIG. 8) the display controller 32 displays a message indicating the user to make a predetermined operation to the area displayed in an emphasized manner at S3. Examples of the predetermined operation include selecting the area displayed in an emphasized manner with the cursor 20 by operating the touch pad 3 (see FIG. 2), touching the area displayed in an emphasized manner with a finger or a stylus (see FIG. 3), and displaying the hover image 21 by bringing a finger or a stylus near the area displayed in an emphasized manner (see FIG. 4). The processing then goes to S6.

At S6, the input controller 31 receives the operation for the area displayed in an emphasized manner. The processing then goes to S7.

At S7, the calculating module 35 determines whether any operation has been made for the area displayed in an emphasized manner.

If the calculating module 35 determines that no operation has been made for the area displayed in an emphasized manner at S7, the processing returns to S6. If the calculating module 35 determines that some operation has been performed to the area displayed in an emphasized manner at S7, the processing goes to S8.

At S8, the second acquiring module 34 acquires the first coordinates. The first coordinates are, as mentioned earlier, one of the coordinates indicating the position at which the cursor 20 is displayed (see point P1 in FIG. 2), the position of the touch panel 1a touched by a user (see point P2 in FIG. 3), and the position at which the hover image 21 is displayed (see point P3 in FIG. 4), in the display area R0. In this manner, the second acquiring module 34 acquires the first coordinates at the timing when the operation is performed to the area displayed in an emphasized manner. The processing then goes to S9.

At S9, the calculating module 35 determines whether the first coordinates acquired at S8 are positioned inside the area displayed in an emphasized manner at S3.

If the calculating module 35 determines that the first coordinates are not inside the area displayed in an emphasized manner at S9, the processing returns to S5. If the calculating module 35 determines that the first coordinates are inside the area displayed in an emphasized manner at S9, the processing goes to S10.

At S10, the calculating module 35 stores therein the first information acquired at S4 and the first coordinates acquired at S8, in association with each other. The processing then goes to S11.

At S11, the calculating module 35 determines whether all of the areas R1 to R5 have been selected. In other words, the calculating module 35 determines if all of the sections of the calibration screen 40 have been displayed in an emphasized manner, by repeating the process at S3. The calculating module 35 manages whether all of the areas R1 to R5 have been selected using a list, for example.

If the calculating module 35 determines that any of the areas R1 to R5 has not been selected at S11, the processing then goes to S12. At S12, the calculating module 35 selects the unselected one of the areas R1 to R5. The processing then returns to S3. This allows S3 to S12 to be repeated until all of the areas R1 to R5 are selected (until all of the sections of the calibration screen 40 are displayed in an emphasized manner), and, as a result, a pair of the first information and the first coordinates is stored in in association with each other, by the number of times equal to the number of the areas R1 to R5.

If the calculating module 35 determines that all of the areas R1 to R5 have been selected at S11, the processing then goes to S13. At S13, the calculating module 35 calculates a calibration value for improving the detection accuracy of the user's line of sight, based on the correspondence between the first information and the first coordinates stored at S10. The calculated calibration value is stored in a storage medium such as the memory 9 or the HDD 10. The calibration value stored in the storage medium is read as required, when a line-of-sight detection is performed using the infrared camera 5. The calibration value herein is a setting value for estimating the position at which a user is looking in the display area R0. More specifically, a calibration value is a value for calibrating an error between the position at which the user is actually looking in the display area R0 and the position at which a user is presumably looking in the display area R0, the latter position being identified based on the image data (first information) acquired by the first acquiring module 33. The processing is then ended.

As described above, in the first embodiment, the calculating module 35 is configured to calculate a calibration value for estimating a position at which a user is looking in the display area R0, based on the first coordinates acquired by the second acquiring module 34 and the first information acquired by the first acquiring module 33 when the first coordinates are acquired. The first coordinates are coordinates of one of the position at which the cursor 20 is displayed, a position of the cursor 20 configured to move in the display area R0 by following an operation of a user on the touch pad 3 (see point P1 in FIG. 3), a touched position that is the position at which a user touches the touch panel 1a (see point P2 in FIG. 4), and a position of the hover image 21 displayed in the display area R0 when a user performs a hover operation that is an operation of pointing to the touch panel 1a without touching the touch panel 1a (see point P3 in FIG. 5), in the display area R0. The first information is information indicating a positional relation between the position of a reflected light on the user's pupil and the position of the reflected light on a user's cornea, the reflected light being an infrared emitted from the infrared LED 4 that is reflected on the user's cornea. Thus, a calibration value can be calculated more easily when the PC 100 is operated with the cursor 20, the touch panel 1a, and the hover image 21, using a user's habitual behavior (instinct) in which the user often looks at the point pointed by the cursor 20 (see point P1 in FIG. 2), the point at which the user touches the touch panel 1a with a finger or a stylus (see point P4 in FIG. 3), and the point at which the hover image 21 is displayed (see point P3 in FIG. 4).

Furthermore, according to the first embodiment, unlike the case that a calibration is performed by displaying on the display 1 a plurality of points to be looked at one at a time, and by detecting a user's line of sight when the user looks at each of the points, the points being at different positions, for example, the user can perform the calibrating operation at his/her own pace so that the usability can be improved. The calibrating operation is an operation of bringing the cursor 20, the touched position, or the hover image 21 inside the area displayed in an emphasized manner of the calibration screen 40.

### Second Embodiment

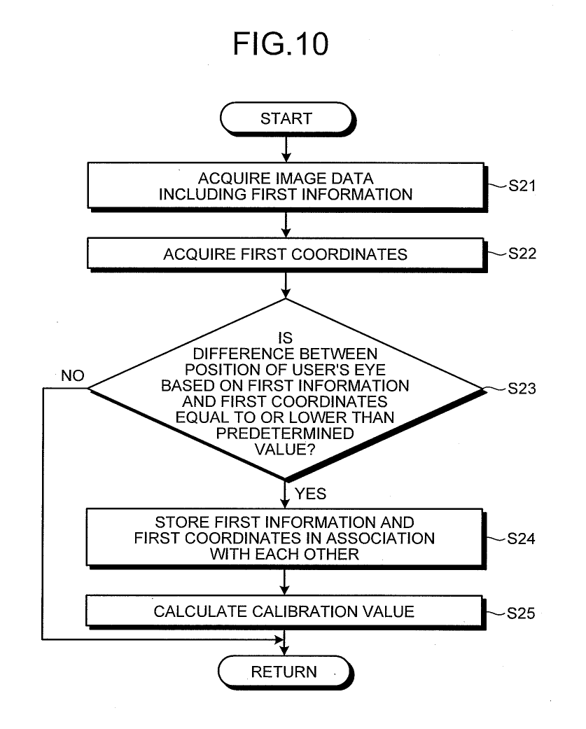

A calibration program 30a according to a second embodiment will now be described with reference to FIGS. 6 and 10. Unlike the calibration program 30 according to the first embodiment executed only once when the PC 100 is operated for the first time with the line-of-sight detection, this calibration program 30a is executed at any time while the PC 100 is being operated with the line-of-sight detection.

A first acquiring module 33a (see FIG. 6) according to the second embodiment is configured to acquire the image data including the first information at any time while the user moves the cursor 20 (see FIG. 2), the touched position (see FIG. 3), or the hover image 21 (see FIG. 4). More specifically, the first acquiring module 33a is configured to acquire the first information at any time while the calibration program 30a is running. Because the definition of the first information is the same as that according to the first embodiment, another description thereof is omitted herein.

A second acquiring module 34a according to the second embodiment (see FIG. 6) is configured to acquire the first coordinates at any time while the user moves the cursor 20 (see FIG. 2), the touched position (see FIG. 3), or the hover image 21 (see FIG. 4), in the same manner as the first acquiring module 33a. More specifically, the second acquiring module 34a is configured to acquire the first coordinates at anytime while the cursor 20, the touched position, or the hover image 21 is moved, regardless of whether an operation of selecting an object or the like is made. Because the definition of the first coordinates is the same as that according to the first embodiment, another description thereof is omitted herein.

An calculating module 35a according to the second embodiment (see FIG. 6) is configured to compare the position of the user's eye that is based on the first information acquired in the manner described above with the first coordinates at any time, and to calculate a calibration value when a difference between the position of the user's eye that is based on the first information and the first coordinates is equal to or lower than a predetermined value (threshold). More specifically, if the position of the user's eye that is based on the first information and the first coordinates are nearby some degree, the calculating module 35a is configured to determine that the user moves the cursor 20, the touched position, or the hover image 21 while looking at the position at which the cursor 20 is displayed (see point P1 in FIG. 2), the touched position (see point P2 in FIG. 3), or the position at which the hover image 21 is displayed (see point P3 in FIG. 4), and the calculating module 35a is configured to calculate a calibration value based on correspondence between the first information and the first coordinates acquired at such timing. Because the definition of the calibration value is the same as that according to the first embodiment, another description thereof is omitted herein.

An exemplary process performed by the modules of the calibration program 30a according to the second embodiment (see FIG. 6) will now be described with reference to FIG. 10.

When the calibration program 30a is started, as illustrated in FIG. 10, at S21, the first acquiring module 33a acquires the image data including the first information by capturing an image of a user's eye with the infrared camera 5. The processing then goes to S22.

At S22, the second acquiring module 34a acquires the first coordinates indicating the position at which the cursor 20 is displayed (see point P1 in FIG. 2), the touched position (see point P2 in FIG. 3), or the position at which the hover image 21 is displayed (see point P3 in FIG. 4). The processing then goes to S23.

At S23, the calculating module 35a determines whether the difference between the position of the user's eye based on the first information acquired at S21 and the first coordinates acquired at S22 is equal to or lower than the predetermined value. In other words, the calculating module 35a determines whether the position of the user's eye that is based on the first information, and the first coordinates are positioned nearby.

If the calculating module 35a determines that the difference between the position of the user's eye that is based on the first information and the first coordinates is higher than the predetermined value at S23, the processing is ended. If the calculating module 35a determines that the difference between the position of the user's eye that is based on the first information and the first coordinates is equal to or lower than the predetermined value at S23, the processing then goes to S24.

At S24, the calculating module 35a stores the first information acquired at S21 and the first coordinates acquired at S22 in association with each other. The processing then goes to S25.

At S25, the calculating module 35a calculates a calibration value for detecting the position at which a user is presumably looking in the display area R0, based on correspondence between the first information and the first coordinates stored at S24. The calculated calibration value is stored in a storage medium such as the memory 9, the HDD 10 or the like. The calibration value stored in the storage medium is read as required, when a line-of-sight detection is performed using the infrared camera 5. The processing is then ended.

As explained above, in the second embodiment, the first acquiring module 33a is configured to acquire the image data and the second acquiring module 34a is configured to acquire the first coordinates at any time while the user moves the cursor 20 (see FIG. 2), the touched position on the touch panel 1a (see FIG. 3), or the hover image 21 (see FIG. 4). The calculating module 35a is configured to calculate a calibration value when a difference between the position of the user's eye that is based on the first information included in the image data and the first coordinates is equal to or lower than the predetermined value. Thus, a calibration value can be calculated based on the first information and the first coordinates acquired as appropriate while a user is making an ordinary operation using the cursor 20, the touch panel 1a, or the hover image 21, thereby the user does not need to perform any special operation for calculating a calibration value. As a result, a calibration value can be calculated more easily.

Furthermore, in the second embodiment, the first acquiring module 33a is configured to acquire the first information and the second acquiring module 34a is configured to acquire the first coordinates at any time, thereby the calculating module 35a can always calculate the latest calibration value based on the latest first information and first coordinates. Thus, even when a calibration value calculated in the past is incapable of calibrating the first coordinates accurately due to the fact that glasses are changed, for example, the calibration value can be updated to an appropriate value.

The calibration programs 30 and 30a according to the first and second embodiments are stored in a ROM in the memory 9. The calibration programs 30 and 30a are provided as computer program products in an installable or executable format. In other words, the calibration programs 30 and 30a are included in a computer program product having a non-temporary and computer-readable recording medium such as a compact disc read-only memory (CD-ROM), a flexible disk (FD), a compact disc recordable (CD-R), or a digital versatile disc (DVD), and are provided.

The calibration programs 30 and 30a may be stored in a computer connected to a network such as the Internet, and provided or distributed over the network. The calibration programs 30 and 30a may also be embedded and provided in a ROM, for example.

The calibration programs 30 and 30a have a modular configuration including the modules described above (the input controller 31, the display controller 32, the first acquiring module 33, the second acquiring module 34, and the calculating module 35). As actual hardware, by causing the CPU 11 to read the calibration programs 30 and 30a from the ROM of the memory 9 and to execute the calibration programs 30 and 30a, the modules are loaded onto the RAM in the memory 9, thereby generating the modules on the RAM in the memory 9.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A method comprising:
acquiring first image data comprising first information related to a first position of a user's eye at a first time by capturing an image of a user's eye;
acquiring a first coordinate at a second time substantially same as the first time, the first coordinate being a coordinate of a pointer comprising to move in a display area on a first screen by following an operation of a pointing device by a user, or a coordinate of a touched position at which a user touches a display area of a touch panel; and
calculating a calibration value for estimating a second position at which the user is looking in the display area using the first information and the first coordinate.

2. The method of claim 1, wherein the first coordinate of the pointer is acquired when a user selects an object by the pointer.

3. The method of claim 1, wherein
the first coordinate is acquired at any time while a user is moving the pointer or a touch position.

4. The method of claim 1, further comprising:
displaying a second screen on the display area, the second screen comprising to notify a user to bring the pointer or the touched position sequentially into divided areas of the display area; and
sequentially acquiring the first image data and the first coordinate every time the user brings the pointer or the touched position inside any of the divided areas.

5. The method of claim 1, wherein the first coordinate is acquired after the first image data is acquired.

6. An electronic device comprising:
processing circuitry to acquire first image data comprising first information related to a first position of a user's eye at a first time by capturing an image of a user's eye, to acquire a first coordinate at a second time substantially same as the first time, and to calculate a calibration value for estimating a second position at which the user is looking in a display area on a first screen using the first information and the first coordinate, the first coordinate being a coordinate of a pointer comprising to move in the display area by following an operation of a pointing device by a user, or a coordinate of a touched position at which a user touches a display area of a touch panel.

7. The electronic device of claim 6, wherein the processing circuitry comprises to acquire the first coordinate of the pointer when a user selects an object by the pointer.

8. The electronic device of claim 6, wherein the processing circuitry comprises to acquire the first coordinate at any time while a user is moving the pointer or a touch position.

9. The electronic device of claim 6, wherein the processing circuitry comprises to display a second screen on the display area and to acquire the first image data and the first coordinate, wherein
the second screen comprises to notify a user to bring the pointer or the touched position sequentially into divided areas of the display area, and
the processing circuitry comprises to sequentially acquire the first image data and the first coordinate every time the user brings the pointer or the touched position inside any of the divided areas.

10. The electronic device of claim 6, wherein the processing circuitry comprises to acquire the first coordinate after the first image data is acquired.

11. A computer program product having a non-transitory computer readable medium including programmed instructions, wherein the instructions, when executed by a computer, cause the computer to perform:
acquiring first image data comprising first information related to a first position of a user's eye at a first time by capturing an image of a user's eye;
acquiring a first coordinate at a second time substantially same as the first time, the first coordinates being coordinates of a pointer comprising to move in a display area on a first screen by following an operation of a pointing device by a user, or a coordinate of a touched position at which a user touches a display area of a touch panel; and
calculating a calibration value for estimating a second position at which the user is looking in the display area using the first information and the first coordinate.

12. The computer program product of claim 11, wherein the first coordinate of the pointer is acquired when a user selects an object by the pointer.

13. The computer program product of claim 11, wherein the first coordinate is acquired at any time while a user is moving the pointer or a touch position.

14. The computer program product of claim 11, wherein the instructions further cause the computer to perform:
displaying a second screen on the display area, the second screen comprising to notify a user to bring the pointer or the touched position sequentially into divided areas of the display area; and
sequentially acquiring the first image data and the first coordinate every time the user brings the pointer or the touched position inside any of the divided areas.

15. The computer program product of claim 11, wherein the first coordinate is acquired after the first image data is acquired.
